(19) United States
(12) Patent Application Publication
(10) Pub. No.: US 2021/0378248 A1
(43) Pub. Date: Dec. 9, 2021

(54) Apparatus For Fermenting Dough Pieces, And Method, In Particular For Operating Such An Apparatus For Fermenting

(71) Applicants: Albert REICHENBACH, Iserlohn (DE); Klaus LÖSCHE, Bremerhaven (DE)

(72) Inventors: Albert REICHENBACH, Iserlohn (DE); Klaus LÖSCHE, Bremerhaven (DE)

(21) Appl. No.: 16/962,296

(22) PCT Filed: Jan. 18, 2019
(86) PCT No.: PCT/EP2019/051204

§ 371 Date: Jul. 15, 2020

(30) Foreign Application Priority Data
Jan. 18, 2018 (DE) 10 2018 101 068.0

(51) Int. Cl. A21C 13/00

(52) U.S. Cl. CPC A21C 13/00

(57) ABSTRACT

A leavening apparatus for leavening dough pieces comprises a leavening chamber for receiving dough pieces and a climate control module for controlling the climate in the leavening chamber for the leavening process. A control device for controlling the leavening process according to climate data detected in the leavening chamber is paired with the climate control module. The climate control module comprises a device for creating an air stream and a device for creating water aerosol to be entrained by the air stream. The leavening chamber has an upper inlet for the climate control media ‘air’ and ‘moisture’ provided by the climate control module, and a lower outlet the opening width of which can be adjusted. During operation, an air stream generated by the climate control module is introduced via said inlet into the leavening chamber, said air stream flowing out of the outlet of the leavening chamber. The leavening chamber further has one each of a temperature sensor, a moisture sensor and a CO₂ and/or O₂ sensor, said sensors being configured to transmit the detected climate data to the control device. A method for conditioning the climate in the leavening chamber of a leavening apparatus of this kind is also described.

### BACKGROUND

The present disclosure relates to a fermenting apparatus, also referred to as a leavening apparatus for fermenting or leavening dough pieces and a method for controlling the climate in the leavening chamber of a leavening apparatus for leavening dough pieces in the leavening chamber.

Bakeries use leavening apparatuses for leavening dough pieces. Such leavening apparatuses may be mobile or larger apparatuses or even rooms firmly installed in a building. A distinction can be made between leavening apparatuses that are configured to work continuously and leavening apparatuses that are not configured to work continuously. Such a leavening apparatus comprises a leavening chamber, into which the dough pieces to be leavened are inserted. Typically, the dough pieces are placed on leavening boards with a plurality of sheets with dough pieces being arranged one above the other in such a leavening chamber. In non-continuously working leavening apparatuses, a plurality of leavening boards is arranged one above the other in the leavening chamber. In continuously working leavening apparatuses, these are conveyed by continuous conveyors or other conveyors such as a Pater Noster system.

Dough pieces to be baked generally have to be leavened first so that the dough obtains its desired characteristics such as softness, consistency or leavened volume. During the leavening process, the baker's yeast or sourdough bacteria used to perform the leavening produce CO₂, among other things. A significant part of the leavening products generally remains in the dough. The other part is emitted into the environment. Temperature plays an important role in the leavening process. A higher temperature accelerates the leavening process while a lower temperature slows the leavening process or if the temperature is low enough, even prevents this process.

In modern leavening apparatuses, which are configured, for example, as leavening cabinets, the process is controlled by the temperature and sometimes additionally by the relative air moisture. To achieve the desired dough quality, the temperature is controlled accordingly in such a leavening cabinet. The temperature control may differ depending on the baked goods that are to be produced from the dough pieces. The temperature is generally held constant in leavening rooms. A specific temperature profile is followed in leavening control methods and/or in leavening machines, depending on the characteristics of the dough piece to be leavened. Depending on the method used, temperatures between +35° C. and −15° C. are maintained. The target variable is typically the time at which the leavening process ends.

In bakeries that do not bake around the clock and where the dough pieces cannot always be promptly processed further after the leavening process has ended, the temperature control of the leavening process is set in accordance with the time of the next bake. This comprises the process of the so-called leavening interruption or leavening delay. As part of this process, the temperature in a leavening machine is lowered such that, depending on the design of the process, the leavening process is very slow for a certain period of time or completely interrupted.

During the leavening, CO₂ is generated in the leavening chamber among other things, which first stratifies itself at the bottom due to its molecular weight. If the leavening chambers are walk-in leavening apparatuses, this may be problematic if the CO₂ concentration is too high when someone opens the leavening chamber to check the degree of leavening or to remove the leavened dough pieces from the chamber, in particular in terms of hygiene and health. Over the course of the process, the ambient air in leavening chambers may reach CO₂ concentrations ranging from 3000 to 7000 ppm or even more. This goes hand in hand with a respective enrichment of the concentration of other leavening products such as ethanol, aromatics and the like and a respective depletion of the oxygen content.

In leavening apparatuses of the type in question, the temperature in the leavening chamber is monitored for the required temperature control. Monitoring the relative water content in leavening chambers is a common practice as well. In certain prior art leavening apparatuses, water vapor is introduced into the leavening chamber to regulate the relative water content. The water vapor is hot. In a simple case, the vapor is distributed within the leavening chamber by rising convection or at least supported by such convection. This is also how the temperature in the leavening chamber is increased. If, however, the objective is to lower the temperature in the leavening chamber, cold air is introduced. Even though it is possible to achieve satisfactory baking results with such leavening apparatuses, increasing hygiene problems must be anticipated in the long term due to critically high CO₂ values, which, in particular, pertain to an undesired growth of mold. Consequently, cleanliness is of particular importance for these leavening apparatuses, especially when they are not in use.

It would additionally be desirable to further improve the quality of the leavened dough pieces and the leavening process as well as the associated quality of the baked goods.

DE 196 38 664 A1 discloses a cooking apparatus for cooking food. This cooking apparatus consists of a cooking receptacle, which is arranged in an oven muffle and which, with a steam inlet, is connected to a steam outlet arranged in the oven muffle. The cooking apparatus comprises a steam outlet, which is arranged above it. This cooking apparatus uses hot steam for the leavening process. A temperature sensor is located above the steam outlet of the cooking receptacle. The cooking process is controlled by means of the steam temperature emitted from the cooking receptacle. A distinction is made in the hot steam cooking process between a first heating phase and a subsequent cooking phase.

DE 10 2008 036 683 A1 discloses a further cooking apparatus and a method for controlling a cooking process. This cooking apparatus is a convection steamer. In this cooking apparatus, the air that flows through a cooking receptacle is used to influence the cooking process, for example if the food is to be cooked by means of browning sensors. The gas concentration change is monitored during the cooking process on the outlet side with respect to the cooking receptacle to be able to draw conclusions about the progress of the cooking process of the food to be cooked.

These two apparatuses are not, however, apparatuses for the fermentative leavening of dough pieces but cooking apparatuses that require comparatively high temperatures (90° C., for example) to make certain types of food such as meat, potatoes, etc., edible.

The foregoing examples of the related art and limitations therewith are intended to be illustrative and not exclusive.

### SUMMARY

Proceeding from this background, an aspect of the present disclosure is to propose a leavening apparatus for leavening dough pieces with which the leavening process of the dough pieces can be improved as well as the method for controlling the climate in the leavening chamber of the leavening apparatus discussed above.

This is achieved by a leavening apparatus for leavening dough pieces comprising a leavening chamber that receives dough pieces to be leavened and a climate control module for controlling the climate in the leavening chamber during the leavening process, with said climate control module being associated with a control device for controlling the leavening process on the basis of climate data detected in the leavening chamber, with said climate control module comprising a device for creating an air stream as well as a device for creating water aerosol to be entrained by the air stream, and wherein the leavening chamber has an upper inlet for the climate control media ‘air’ and ‘moisture’ and a lower outlet, the opening width of which can be adjusted, and via which inlet an air stream generated by the climate control module is introduced into the leavening chamber during operation of the leavening apparatus for leavening dough pieces, with said air stream flowing out of the outlet of the leavening chamber, and said leavening chamber further having one of each of a temperature sensor, a moisture sensor and a CO2 and/or an O2 sensor, with said sensors being configured to transmit the detected climate data to the control device.

The method-related aspect above is provided by a method for controlling the climate in the leavening chamber of a leavening apparatus for leavening dough pieces, wherein
a) climate data influencing the leavening process is detected during the leavening process in the leavening chamber, wherein the conditioning variables temperature, absolute water content and the CO₂ and/or O₂ content are detected as ACTUAL climatic data values and compared with the TARGET values provided for the dough pieces to be leavened, and
b) when a deviation between an ACTUAL value and the associated TARGET value is found, the climate in the leavening chamber is influenced to adjust the ACTUAL value to the TARGET value and, to influence the same, an air stream is introduced into the leavening chamber via an upper inlet and passed through the leavening chamber whereby
   (i) an influence is exerted with respect to an adjustment of the ACTUAL temperature to the TARGET temperature by the introduced air volume and/or the temperature of the introduced air volume,
   (ii) an influence is exerted with respect to an adjustment of the absolute ACTUAL water content to the absolute TARGET water content by a corresponding water aerosol concentration of the air stream, and
   (iii) an influence is exerted on the adjustment of the CO₂ and/or O₂ ACTUAL value to the TARGET value by a change to the volume flow of the air stream flowing through the leavening chamber.

The term of leavening chamber used within the context of these explanations comprises any and all spaces or chambers enclosed by limits such as walls, separations and the like into which dough pieces are placed for leavening purposes. Consequently, the leavening chamber may be a simple leavening apparatus, the space of a firmly installed leavening apparatus or even the space in a fully automated leavening machine into which the dough pieces are placed for leavening purposes.

This leavening apparatus improves and better controls the leavening process of the dough pieces placed in the leavening chamber in that an air stream is passed through the leavening chamber so as to adjust the climate for the leavening process. To this purpose, the leavening chamber comprises an upper inlet and a lower outlet, the opening width of which and thus the cross-section area through which air can flow can be adjusted. To make the adjustment, typically an electrically controllable actuator will be used to actuate an outlet slide or an outlet flap. The temperature of the leavening chamber and/or the dough pieces in it can be adjusted by means of the air stream.

At the same time, the air stream, with which aerosol can be introduced into the leavening chamber to adjust the absolute water content in the environment of the dough pieces, serves as a transport medium in the leavening apparatus. What is advantageous about this concept compared to known leavening apparatuses is that it is not necessary to use two different media for the temperature control, i.e., one for heating purposes and one for cooling purposes. The advantage lies in the provision of the ambient moisture required for the leavening process by water aerosol entrained by the air stream. The temperature is controlled by the temperature of the air stream and/or the aerosol. By controlling the temperature of the leavening receptacle by means of the air stream flowing through said receptacle, it is possible to adjust the temperature in the environment of the dough pieces to be leavened in a very precise manner. This ensures that the maximum leavening temperature is not exceeded. For yeast, this is at around 40° C. Even within the possible leavening temperature, desired leavening temperatures can be exactly maintained in this manner, for example higher leavening temperatures of around 35 to 37° C. or lower leavening temperatures of around 20 to 25° C. At the same time, this ensures that the temperature of the yeast does not fall below the temperature at which the yeast is no longer active. This is the case at around −9° C. This applies similarly when using sourdough bacteria.

The air stream flowing through the leavening chamber of the leavening apparatus may be used to dry the same when the leavening apparatus is not used, which prevents the risk of mold during non-use. In that case, the air stream is typically not mixed with aerosol.

By being able to introduce water aerosol into the leavening chamber, the moisture content in the environment of the leavening dough pieces is adjusted. It is advantageous that the aerosol can also be used as a heat carrier and that an adjustment of the air moisture does not, in contrast with the use of water steam, depend on the temperature. The aerosol can be generated from a liquid of any temperature.

In a preferred embodiment of such a leavening apparatus, the air stream flows through the leavening chamber in the vertical direction. Even if designing the leavening apparatus in numerous application cases so that the air stream flows through the leavening chamber in the vertical direction from the top to the bottom, which is advantageous with respect to the CO₂ generated during the leavening process, such an air stream can flow through the leavening chamber in the opposite direction from the bottom to the top as well. Since the air stream flows vertically through the leavening chamber, a climatic layer formation of the leavening chamber is counteracted. It may be helpful for a leavening process to provide the air stream in different directions during the leavening process, for example when the generated CO₂, which tends to descend due to its specific weight, is to be supplied to the dough pieces on the upper levels by an air stream that flows in the opposite direction.

It may be provided that a fan or a fan unit is attached to the inlet opening of the air stream, via which it enters the leavening apparatus so as to generate the desired air stream. In the case of a vertical air stream, the inlet opening is found above the leavening chamber with the outlet in the lower region of the leavening chamber, typically in the region of the bottom. In principle, an air stream can also be generated by providing a fan or a fan unit in the region of the outlet and not in the region of the inlet opening. In a further development of such a leavening apparatus, it is provided that a fan or a fan unit is arranged both in the region of the inlet opening and in the region of the outlet with the terms “inlet opening” and “outlet” pertaining to the direction of flow of the air stream. Especially in an embodiment with two fans or fan units, wherein one fan each or one fan being attached to the inlet opening and at least a further fan being attached to the outlet, an air stream can be generated that alternates with respect to its direction of flow. A different operation of the inlet and outlet fan or fan unit with respect to the speed of their propellers may increase the pressure in the leavening chamber with or without adjusting the opening width of the outlet. Such a fan may be a blower, for example. In the case of a fan unit, a plurality of fans is joined to form a fan unit, for example in a juxtaposition.

What is special about this leavening apparatus and/or the method described is that the air stream flows through the leavening chamber, and the air stream is generally not conveyed in a convection mode, which means that the air stream flowing from the outlet enters the leavening apparatus again via the inlet opening. Rather, ambient air is suctioned from outside the leavening apparatus via the inlet opening. Such a leavening apparatus can, when designed accordingly, temporarily be operated in a convection mode as well when this is advantageous for adjusting or maintaining a preset climate in the environment of the dough pieces in the leavening chamber.

The aerosol introduced into the leavening chamber by means of the air stream may contain additives that depend on the desired application. It is possible to use the aerosol as a carrier of anti-microbial and/or anti-fungal substances that may be used to clean the leavening receptacle, in that case possibly in a somewhat higher concentration, or also to protect the leavening dough pieces, in that case possibly in a somewhat lower concentration. The aerosol may also be used to positively influence the leavening process itself, for example when the aerosol or the aerosol droplets are enriched with oxygen. Such an oxygen enrichment can increase the oxygen content in the direct environment of the dough pieces. This way, the oxygen content required for the leavening process and the dough oxidation can be optimized in the environment of the dough pieces and therefore in the leavening chamber for the leavening process, even at higher CO₂ concentrations. Water aerosol mixed with ascorbic acid and imbued or enriched with O₂ has a similar but stronger effect on the leavening process and therefore on the overall quality of the dough and the baked goods.

The leavening apparatus comprises a climate control module with a control device for controlling the leavening process and the dough stabilization. The control device comprises a device for the generation of an air stream as well as a device for the generation of the aerosol to be entrained by the air stream. Furthermore, a plurality of sensors detecting climatic variables inside the leavening chamber is connected to the control device, the data of which influences the control device. These are at least one temperature sensor, one moisture sensor and one CO₂ and/or O₂ sensor. What is critical for this leavening apparatus and the method according to the present disclosure is the monitoring and control of the CO₂ and/or O₂ ACTUAL content in the leavening chamber. It is provided in one embodiment to arrange one each of such sensors at different levels of the leavening chamber.

It was found to be surprising in the testing that led to this present disclosure that it is possible to control the leavening process not only via the temperature but also via the CO₂ content in the environment of the dough pieces which makes it possible to control, in particular, the quality of the leavened dough pieces and the respective baked goods. A certain CO₂ content in the environment is advantageous for the leavening process. The atmospheric CO₂ content may not be too high, however. It is also possible to control the creation of ethanol associated with the leavening process via the CO₂ content and the temperature. The ethanol that forms during the leavening process equimolar to CO₂ partially remains in the dough, but other parts escape into the ambient atmosphere. In the event of critical concentrations, however, this has a negative effect on the quality of the leavened dough piece and the baked goods produced. In this regard, this leavening apparatus and the method according to the present disclosure make it possible to control the CO₂ content over the course of the leavening process. Alternatively, an oxygen sensor may also be used, because oxygen is required to initiate the leavening process. The oxygen reduction in the atmosphere of the leavening receptacle primarily results from the corresponding diluting effects as a consequence of the enrichment of leavening gases (CO₂, ethanol, etc.) over the course of a leavening process and a certain oxygen consumption by oxidative conversion reactions in the dough piece. An oxygen uptake via the surface of the dough pieces clearly leads to a significant improvement of the leavening activity and to dough pieces with a higher leavening stability. In one embodiment of such a leavening apparatus, both CO₂ and O₂ sensors are installed.

To achieve a certain dough quality of the dough pieces during the leavening process, a certain oxygen content is required in the atmosphere during the leavening. This requirement contrasts with the anaerobic leavening process during which CO₂ is generated, for example. With the possibilities of the leavening apparatus described above, the leavening process can be controlled especially well with respect to the oxygen required on the one hand as well as for the CO₂ required for the leavening process on the other.

Oxygen is necessary for the leavening process and for the creation of aroma-active substances. Likewise, O₂ induces the biosynthesis of such substances that make the yeast more resistant against stress situations such as freezing and defrosting. Furthermore, the dough rheology as well as the baked goods volume made from it can be positively influenced by a minimum oxygen content. Wheat doughs are typically oxidatively stabilized.

The detection of the CO₂ content increases the occupational safety, especially in larger leavening apparatuses, for example those that can be walked into to place and remove dough pieces. If the CO₂ content in the leavening chamber is too high, this can be displayed so that the leavening chamber cannot be entered. In principle, this can also be combined with a door lock such that the door of the leavening chamber can only be opened when the CO₂ content has dropped below a certain threshold and/or has not exceeded the same. Due to the specific weight of CO₂, the CO₂ sensor(s) would be arranged in the lower third of the height of the leavening chamber. This does not rule out that one or more further CO₂ sensors can be provided in the upper region as control sensors.

The monitoring of the CO₂ and/or O₂ content in the leavening chamber does not only allow for a control of the quality of the dough and the baked goods on the basis of the leavening influenced in this manner but also, at the same time, the inhibiting effect of an excessive CO₂ content in the environment of the food to be leavened on the leavening process can be avoided by ensuring that the CO₂ content does not exceed a certain concentration. The dough quality is improved by controlling the CO₂ content in the environment of the dough pieces in that they do not spread out too widely, almost do not stick to each other and have a browning level that has a positive effect on the aroma and the taste. Controlling the CO₂ content may also lead to a reduction of baking improvers.

The air moisture in the leavening chamber controlled by the supply of aerosol and the air stream flowing through the leavening chamber make it possible to control the hygiene in the leavening chamber. This creates, in particular, the possibility to effectively prevent the formation of mold.

The aerosol entrained by the air stream and the thus controlled air moisture in the environment of the dough pieces make it possible to provide an optimized heat conductivity which makes it possible to avoid a so-called coating.

With the CO₂ concentration and the counteracting O₂ concentration, it is also possible to respond to the needs of different baking agents used in the dough pieces to optimize the leavening process. It is possible, for example, to provide a different CO₂ and/or O₂ environment for a dough piece with an oxidatively acting baking improver for the leavening process than for dough pieces that do not contain an oxidative baking improver.

In a further development, it is provided that, in addition to the already mentioned climate data, the pressure in the leavening chamber is detected as well. Using the air pressure, it is possible to minimize the partial water vapor pressure from the dough piece. To achieve this, the air pressure in the leavening chamber is adjusted accordingly. This can be controlled with the volume flow through the leavening chamber, both by means of the air volume conveyed by means of a blower and by setting the opening width of the outlet opening. The inner pressure in the leavening chamber can be adjusted with these measures as well.

The partly critical CO₂ and ethanol values in leavening chambers of leavening apparatuses such as leavening machines as well as the correspondingly reduced partial oxygen pressures create conditions that are hygienically alarming because these are optimum pre-conditions for the undesired growth of microorganisms, in particular mold. Maintaining sufficiently high O₂ values and maximum CO₂ values (including ethanol) is therefore hygienically required and productive as well.

The climate control module may be an integral component of the leavening apparatus. In such a case, the climate control module is arranged above the leavening chamber. Ambient air is suctioned through an opening that serves as an inlet opening and then conveyed through the climate control module with its temperature adjusted and provided with the respectively desired aerosol concentration. The air stream flows through the leavening chamber from the top to the bottom to thus be able to effectively remove CO₂ from the leavening chamber if this is desired. If a certain CO₂ content is to be present in the atmosphere in the leavening chamber, the opening width of the outlet is reduced accordingly, or this outlet is closed completely so that then the leavening apparatus works in the convection mode to provide a homogeneous climate in the leavening chamber.

In another embodiment, it is provided that the leavening chamber is connected to a climate control module with an inlet located in the upper region. Typically, such a leavening chamber also has an outlet at the bottom, which is connected to the climate control module as well. Such an embodiment offers the possibility to connect even a plurality of leavening chambers to such a separate climate control module. It is provided that each leavening chamber can be adjusted and/or controlled separately from the other leavening chamber(s) with respect to its/their climate control.

It is possible to control the climate in the leavening chamber with an air stream within a very short period of time, basically spontaneously, both with respect to a desired temperature change, a change of the flow speed or also the aerosol concentration. This not only leads to a fast adjustment of an ACTUAL value to a TARGET value when a discrepancy is determined but also makes it possible to control these conditioning variables, be it to keep a climatic environment of the food constant or during temperature change processes throughout the conditioning process. For this reason, this method, which includes climatic data that is collected outside the leavening chamber and/or the leavening apparatus and typically outside the building in which the leavening chamber and/or the leavening apparatus is located in the control process, is suitable for improving the adjustment of the desired quality of the dough pieces. If necessary, such influence is then exercised in an anticipatory manner to avoid larger setpoint jumps within the leavening chambers. Such setpoint jumps may be caused by the air pressure, for example. If, possibly due to a change in the weather outside the building, the absolute water content, the temperature and/or the air pressure change quickly, this will have an effect in the leavening chamber with a certain delay. To avoid having to spontaneously control a larger setpoint jump then detected in the leavening chamber across its entire cycle, which may result in an overshooting or undershooting, it is possible to react to the expected setpoint jump in an anticipatory manner by changing at least one of the variables in a timely manner. When exercising this influence, the time that such a climatic change found outside the leavening chamber requires to have an effect in the leavening chamber is taken into consideration. Consequently, climatic changes occurring outside the leavening chamber then cannot have a negative effect on the quality of the leavening process. Thus, a high quality of the production-related temperature change process can be guaranteed on a consistently high level even in the event of quick climatic changes in the environment of the leavening chamber.

With this method, regularly recurring climatic changes outside the leavening chamber such as the course of the temperature throughout the day, with which also the dew point, the absolute water content in the ambient air changes as well, can be anticipated. The same applies accordingly to seasonal changes of these climatic variables.

In case that a leavening delay or leavening interruption is to be performed by the leavening apparatus, causing the temperature in the leavening chamber to be cooled to the required temperatures, the climate control module must have a cooling aggregate. This aggregate provides the temperatures required for a leavening delay and/or a leavening interruption, depending on the process control. The supply of water aerosols to temperatures from approximately −5° C. to −8° C. is generally not a problem. Below this temperature, a snow formation generally occurs.

In addition to aspects and embodiments described above, further aspects and embodiments will become apparent by reference to following descriptions and accompanying drawings.

### BRIEF DESCRIPTION OF THE DRAWINGS

The following description utilizes example embodiments with reference to the appended figures, wherein:

FIG. 1 shows a schematic representation of a leavening apparatus for leavening dough pieces,

FIG. 2 shows a schematic representation of a leavening apparatus for leavening dough pieces according to a further development of the leavening apparatus of FIG. 1,

FIG. 3 shows a diagram representing the CO₂ content in the leavening chamber of a leavening apparatus configured as a fully automated leavening machine during a leavening process after a 0° C. leavening delay, and

FIG. 4 shows a diagram similar to that of FIG. 2, showing the CO₂ content in the leavening chamber of a fully automated leavening machine after a dough piece storage temperature of approximately −5° C. to −10° C. (leavening interruption).

It is to be understood that the invention is not limited in application to the details of the example embodiments shown, since the invention is capable of other embodiments. The embodiments and figures disclosed herein are to be considered illustrative rather than limiting.

### DETAILED DESCRIPTION

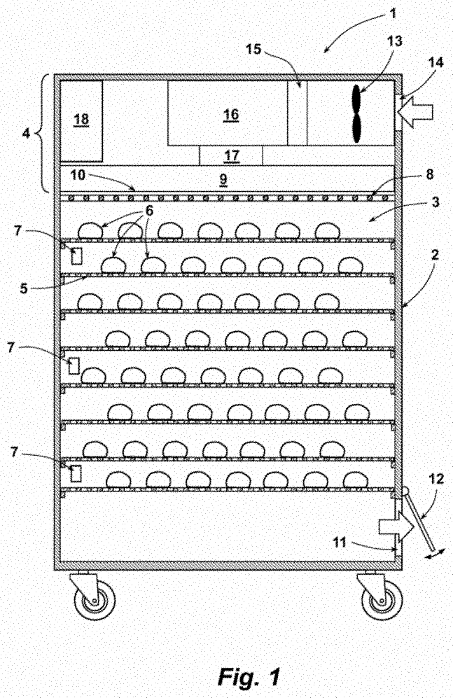

FIG. 1 shows a schematic representation of a leavening apparatus 1 for leavening dough pieces from which baked goods are baked. The leavening apparatus 1 of the example embodiment shown is a mobile leavening cabinet. The leavening apparatus 1 comprises a temperature-insulated housing 2. The housing 2 is divided into two superimposed areas, wherein the lower part of the housing 2 encloses a leavening chamber 3. The upper part of the housing 3 encloses a climate control module that is identified with the reference sign 4. On the inside of the housing, the leavening chamber 3 comprises a plurality of superimposed assemblies for receiving one leavening sheet 5 each on which the dough pieces 6 to be leavened are arranged. The leavening sheets 5 are perforated sheets. In the embodiment shown, the leavening chamber 3 has three sensor assemblies 7. In the embodiment shown, the sensor assemblies 7 are found at three different levels of the leavening chamber 3. Each sensor assembly is designed as a quad sensor and comprises a CO₂ sensor, a temperature sensor, a moisture sensor as well as a pressure sensor. Providing three sensor assemblies 7 makes it possible to detect climatic data that is monitored for the leavening process at different levels to ensure during the leavening process that the climatic conditions are the same throughout the leavening chamber 3.

A grid 8 separates the leavening chamber 3 from the climate control module 4. A collector 9, which extends across the inner base of the leavening chamber 3, is arranged above the grid 8 as part of the climate control module 4. The collector 9 comprises on its underside a material web 10 through which air mixed with aerosol can flow. The cavity of the collector 9 is used to distribute an airstream introduced into the same across the base of the leavening chamber 3 so that it exits from the collector 9 distributed substantially homogeneously across this base and is introduced at the top of the leavening chamber 3. In the embodiment shown, the grid 8 constitutes the inlet of the leavening chamber 3. This inlet forms the roof of the leavening chamber 3. An outlet 11 is provided at the base of one of the walls of the housing 2. A regulating flap 12 with which the opening of the outlet 11 can be closed and with which the opening width of the outlet 11 can be adjusted is attached to the outlet 11. The regulating flap 12 is adjusted by an electric actuator that is not shown in the figure.

The climate control module 4 comprises an electrically operated blower 13 for conveying an air stream introduced into the leavening chamber 3. The air stream is suctioned through an inlet opening 14 in the housing 2. The inlet opening 14 and the outlet 11 are located on the same side of the housing 2 of the leavening apparatus 1. The air stream conveyed by the fan 13 first passes through a temperature control device 15 in which the air stream is adjusted to the desired temperature. Having passed through the temperature control device 15, the air stream is then supplied to an aerosol generation device 16. In the embodiment shown, the aerosol generation device 16 is a device adapted to generate aerosol with a droplet size of 0.001 to 0.005 mm or smaller. The generated aerosol droplets are captured and entrained by the air stream flowing through the aerosol generation device 16, even at low flow speeds of the air stream. This is easily possible due to the small droplet size. The aerosol generation device 16 produces the aerosol as sterile water. The aerosol generation device 16 is adapted to add beneficial agents to the water used for the aerosol generation. In the embodiment shown, the leavening apparatus 1 comprises a tank filled with a microbial and/or antifungal solution (not shown in the figure). Should the aerosol droplets contain such a solution, a specific dose is mixed with the water to be atomized prior to the aerosol generation. An oxygen enrichment 17 is provided downstream from the aerosol generation device 16. The purpose of said enrichment is to increase the oxygen content in the aerosol droplets. The objective of this measure is, among others, to provide the dough pieces with sufficient oxygen or to partially activate the yeast. This can be accomplished by an oxygen enrichment of the aerosol, possibly in conjunction with mixing L-ascorbic acid into the oxygen-saturated water aerosol to provide an immediate and particularly effective form of the oxidized L-ascorbic acid as a reaction product or reaction products. Depending on the desired oxygen content in the water aerosol, simply introducing oxygen gas or air may suffice. This makes it possible to achieve oxygen concentrations of 15 to 20 ppm at a water temperature of approximately 10° C. It is possible to achieve better effects on the dough pieces to be leavened with oxygen concentrations in the water aerosol droplets if these have a concentration of 50 to 100 ppm. The desired effect is even higher if the water aerosol droplets additionally contain ascorbic acid. To achieve such oxygen concentrations, the water is pressure-treated. The outlet of the oxygen enrichment 17 ends in the collector 9, from the underside of which the air stream with the aerosol leaves the collector and enters the leavening chamber 3.

In the embodiment shown, the temperature control device 15 also comprises a cooling aggregate to cool the leavening chamber 3 to the temperatures required for a leavening delay or leavening interruption. In the embodiment shown, it is possible to cool the temperature of the leavening chamber 3 to −15° C. with the cooling aggregate of the temperature control device 15.

Part of the climate control module 4 is a control device 18 with the processors, memories and the like that are required to operate the leavening apparatus 1. The sensor assemblies 7 such as the electric actuator controlling the regulating flap 12, which is not shown in the figure, are connected to the control device 18 as well.

The leavening apparatus 1 operates as follows: When the fan 13 is in operation, ambient air is suctioned through the inlet opening 14 and passed through the temperature control device 15. The temperature control device 15 can heat or also cool the air stream, depending on which temperature the air stream entering the leavening chamber 3 is supposed to have. The temperature-controlled air stream then passes through the aerosol generation device 16 and, depending on the absolute moisture content desired in the leavening chamber 3 and the ACTUAL water content, is then mixed with a corresponding aerosol content. If necessary, additives may be added to the aerosol. In the embodiment shown, an oxygen enrichment 17 is provided downstream from the aerosol generation device 16. If desired, said oxygen enrichment can be used to increase the oxygen content in the aerosol. In the collector 9, the air stream introduced into it spreads across the base of the leavening chamber 3 and passes through the respectively permeable material web 10 in the direction of the leavening chamber 3 and enters the leavening chamber 3 from above. The exiting stream is preferably a lamellar stream. Due to the regulating flap 12, which is typically opened when the leavening apparatus 1 is in operation, the air stream exiting the collector 9 passes through the leavening chamber 3 from the top to the bottom and exits from the outlet 11 as waste air. The configuration of the leavening sheets 5 as perforated sheets allows for a homogeneous permeability of the entire leavening chamber 3.

The control device 18 is provided with an operating unit from which one of a plurality of leavening programs can be selected. The leavening programs themselves are individually programmable. The leavening process is controlled on the basis of the climatic data detected by the sensor assemblies 7 within the leavening chamber 3, with the CO₂ monitoring and the CO₂ control constituting a critical component in the process control or regulation. To be able to optimally carry out the leavening process for the dough pieces 6 in view of the desired result, the CO₂ content is monitored and controlled during the leavening process in accordance with a predetermined curve. The CO₂ content in the environment of the dough pieces 6 would be selected in this regard such that it is sufficiently high but not overly high. An overly high CO₂ content in the environment of the dough pieces has a negative effect on the quality of the dough pieces and therefore the baked goods. The same applies to an overly low CO₂ content. It is understood that the CO₂ content initially increases during a first phase of a leavening process due to the activity of the yeasts and/or the sourdough bacteria. The CO₂ content control generally starts when a certain concentration is reached. Said control may but does not have to remain constant over the course of the leavening process. It was surprising to find that the control of the CO₂ content in the environment of the dough pieces significantly influences the quality of the leavened dough pieces and that it can, in particular, be negatively influenced if the CO₂ content is not monitored and controlled.

The leavening process may follow a predetermined temperature curve. Therefore, the temperature of the air stream introduced into the leavening chamber 3 may change throughout the leavening process. In this way, different stages may be completed during the leavening process at different temperatures if this is desired. The temperature is a variable with which the leavening process can be accelerated or slowed down. Consequently, not only the CO₂ content but also the temperature has a direct influence on the leavening process.

In the embodiment shown, the pressure in the leavening chamber 3 is monitored as well. Among other things, this serves the purpose of holding the ambient pressure in the leavening chamber 3 under weather-related different ambient pressures. A pressure reduction from the ambient pressure is not provided in the leavening apparatus 1, but a pressure increase is provided, which can be performed by either increasing the air stream that is supplied and/or reducing the opening width of the outlet 11 by means of the regulating flap 12. This way, weather changes, especially fast weather changes, which may lead to a reduction of the ambient air pressure, can be compensated. The ambient air pressure influences the leavening process as well.

The air moisture desired for the leavening process is provided by infusing the air stream introduced into the leavening chamber 3 with aerosol. This may vary from one dough piece batch to the next. The air moisture of the leavening chamber 3 may easily be adjusted over the course of the leavening process as well.

An overly high CO₂ content may be compensated by introducing oxygen-enriched aerosol to provide the dough pieces 6 with the oxygen required for the leavening process in this manner. Doing so is very efficient because the oxygen in the aerosol droplets reaches the dough pieces 6 and therefore permeates, in an encapsulated manner, the CO₂-containing atmosphere in the direct environment of the dough piece 6 without diluting the CO₂ content in the environment of the dough piece 6, at least not in a noteworthy manner. This way, the dough piece 6 can remain in the CO₂-enriched atmosphere that is advantageous for it during the leavening process, and the dough piece 6 can still be provided with the desired amount of oxygen required for the leavening process so as to optimize the leavening process. This way, both gases desired for the leavening process, CO₂ and O₂, can be provided to the dough pieces 6 in the respectively high concentration. Traditionally, this was not possible because the concentration of the two gases in the environment of the dough pieces 6 is divergent as the leavening process progresses.

An overly high CO₂ content in the leavening chamber may also be diluted or flushed out by a higher volume flow of the air stream permeating the leavening chamber 3.

The CO₂ monitoring also serves the safety aspect that the CO₂ content in the leavening chamber 3 does not reach a critical concentration at the end of the leavening process and that the CO₂ exiting when the leavening chamber 3 is opened does not constitute a health risk for the person operating the leavening apparatus 1. It can therefore be provided that the leavening chamber 3 is flushed with an air stream at the end of the leavening process, thereby removing the CO₂ in a controlled manner. At the same time, the temperature in the leavening chamber 3 is reduced to slow down the leavening process in the dough pieces 6.

The CO₂ exiting from the outlet 11 can be used to accelerate the start of the leavening process of another leavening chamber 3 of a leavening apparatus arranged downstream with respect to the direction of flow of the air stream. In that case, the leavening process already begins with an increased CO₂ concentration. Should, for such or a different purpose, the CO₂ concentration exiting from the outlet 11 not be high enough for a subsequent application, the concentration can be increased by means of a CO₂ trap.

In the example embodiment provided, climatic variables that are detected outside the leavening chamber 3 are included in the control of the leavening process as well. This way, air pressure fluctuations that occur may be counteracted, for example. Furthermore, the control device 18 then also receives values about the temperature, the moisture and the CO₂ content of the ambient air suctioned through the inlet opening 14. This data may also be data obtained from outside the room in which the leavening apparatus 1 is located.

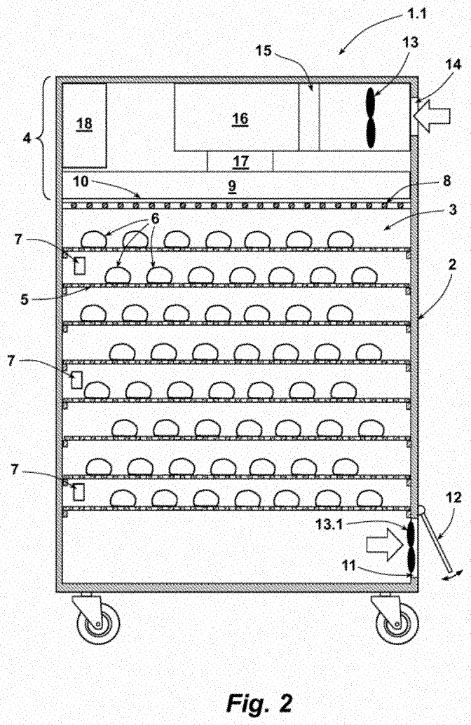

FIG. 2 shows a further leavening apparatus 1.1, which is principally configured in the same way as the leavening apparatus 1 described with respect to FIG. 1. For this reason, the same elements and/or components in the leavening apparatus 1.1 are identified with the same reference signs as the leavening apparatus 1. The leavening apparatus 1.1 comprises, in addition to the fan 13, which is arranged in the region of the inlet opening 14, a second fan 13.1. The fan 13.1 is arranged in the region of the outlet 11. The fan 13.1 is connected to the control device 18 of the climate control module 4. In the leavening apparatus 1.1, the fans 13, 13.1 are typically operated in the same direction. The leavening apparatus 1.1 is able to generate an air stream as already described in connection with the leavening chamber 1, which flows in the vertical direction of the leavening chamber 3 from the top to the bottom. It is possible to influence the air stream within the leavening chamber 3 and also the air pressure in said chamber by varying the speed of the fans 13 and/or 13.1. In this way, the flow speed and the air pressure within the leavening chamber 3 can be influenced independently from the position of the regulating flap 12 as well. In the same way, an interaction between the speeds of rotation of the propellers of the fans 13, 13.1 and the opening width of the regulating flap 12 with respect to the outlet 11 is possible as well. The leavening apparatus 1.1 also makes it possible to create an air stream that flows in the opposite direction and thus enters the leavening chamber 3 from the outlet 11 and exits through the inlet opening 14.

In one embodiment not shown in the figures, such a leavening apparatus also comprises, in addition to the climate control module 4 arranged above the leavening chamber 3 of the leavening apparatus of FIG. 1, a climate control module below the leavening chamber. In such an embodiment, influence can then be exercised on the air stream with respect to the climatic environment of the leavening dough pieces in the leavening chamber 3 in the same way with respect to the temperature and the moisture content, even if the air stream enters through the outlet 11, as described with regard to the leavening apparatus 1 where the air stream enters into the leavening chamber 3 from above from the air control module 4.

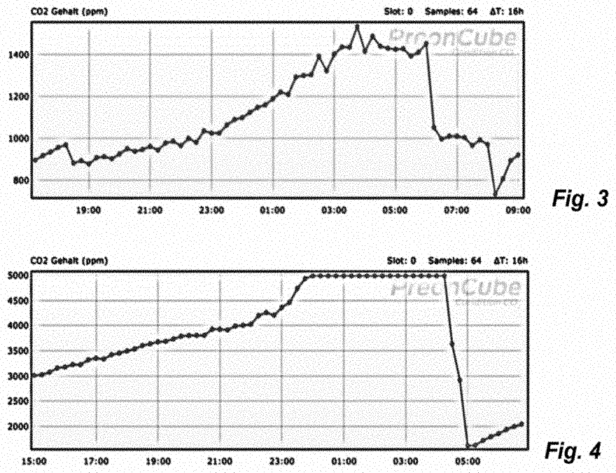

FIG. 3 shows a diagram about the development of the CO₂ content in the leavening chamber of a fully automated leavening machine during a leavening process in which the leavening process of the dough pieces was controlled in accordance with the method described above. This applies both to the CO₂ monitoring, the O₂ monitoring as well as the relative moisture monitoring. The leavening process, for which the CO₂ content curve was recorded, was performed after a 0° C. leavening delay. The leavening process was started around 12:00 AM. Up to this point in time, the temperature in the leavening chamber was around 0° C. Until approximately 4:00 AM, the temperature in the leavening chamber rose to +17° C. and was kept at this temperature until 6:00 AM before the temperature was lowered again. The development of the CO₂ content in the leavening chamber does not exceed the value of 1500 ppm. The method was carried out to ensure that the CO₂ content in the leavening chamber did not exceed a value of 1450 ppm. The progression of the curve section beginning at 2:00 AM until around 6:00 AM shows, due to the fluctuations in the CO₂ content, the method-appropriate influence exercised by controlling the CO₂ content by means of supplying ambient air.

FIG. 4 shows a comparison diagram of a traditionally performed leavening process in a fully automated leavening machine. The leavening process was started at 10:00 PM by increasing the temperature in the leavening chamber. Up to this point in time, the temperature in the leavening chamber had been kept between −5° C. and −10° C. The temperature was also increased to +17° C. in the leavening chamber and lowered in a first step around 2:30 AM to approximately 10° C. At 3:30 AM, the temperature was decreased to −5° C. or colder.

The differences in the CO₂ content in the leavening chamber between the two comparison tests are significant. The CO₂ content in the leavening chamber in which the traditional leavening process was carried out is above 4000 ppm even before the actual start of the leavening process, which is triggered by the temperature increase, and rises to approximately 7000 ppm. Measured values that exceed a content of over 5000 ppm are cut off in the diagram. The CO₂ content that already exists when the temperature increase initiates is the result of a leavening activity that occurs even at a temperature of −5° C.

The CO₂ content controlled and, in particular, to be kept lower in the leavening chamber by the method according to the present disclosure allows for a reduction of the use of baking improvers. Consequently, the monitoring and control of the CO₂ content in the leavening chamber of a leavening apparatus is, independently of its embodiment for an improvement of the dough quality and therefore the quality of the baked goods made from the dough, also an independent advantage in consideration of the resources used, in particular baking improvers. This also applies to the diminished use of baking improvers, which also makes it possible to improve the quality of the baked goods. The diminished use of baking improvers can already be seen in the CO₂ content that is present prior to the temperature increase, which triggers the actual leavening activity. While a CO₂ content of above 4000 ppm is present in the leavening chamber using the traditional method at the time the temperature is increased, the CO₂ content at the beginning of the temperature increase is just slightly above 1000 ppm when using the method according to the present disclosure. The control of the climatic values within the leavening chamber is performed by an ACTUAL/TARGET comparison of the detected data, a method that is generally known already.

The invention has been described herein with the assistance of example embodiments. Those skilled in the art will recognize numerous modifications, permutations, additions and combinations are possible, without these having to be specifically described in the context of this disclosure, and without departing from the scope of the appended claims.

### LIST OF REFERENCE SIGNS

1, 1.1 Leavening apparatus
   2 Housing
   3 Leavening chamber
   4 Climate control module
   5 Leavening sheet
   6 Dough piece
   7 Sensor assembly
   8 Grid
   9 Collector
   10 Material web
   11 Outlet
   12 Regulating flap
13, 13.1 Fan
   14 Inlet opening
   15 Temperature control device
   16 Aerosol generation device
   17 Oxygen enrichment
   18 Control device

1-16. (canceled)

17. A leavening apparatus for leavening dough pieces comprising:
a leavening chamber for receiving dough pieces to be leavened and a climate control module for controlling the climate in the leavening chamber for the leavening process,
wherein a control device for controlling the leavening process on the basis of climatic data detected in the leavening chamber is assigned to the climate control module,
wherein the climate control module comprises a device for generating an air stream as well as a device for generating water aerosol to be entrained by the air stream, and
wherein the leavening chamber comprises an upper inlet for climate control media ‘air’ and ‘moisture’ provided by the climate control module and a lower outlet with an adjustable opening width, and during operation of the leavening apparatus for leavening dough pieces, the air stream generated by the climate control module is introduced into the leavening chamber via the inlet and the air stream flows out from the outlet of the leavening chamber, and
wherein the leavening chamber has one each of a temperature sensor, a moisture sensor and a CO₂ sensor, and said sensors are configured to transmit the detected climatic data to the control device.

18. The leavening apparatus of claim 17, wherein an electric actuator controllable by the control device is provided for adjusting the opening width of the outlet.

19. The leavening apparatus of claim 17, wherein the climate control module is part of the leavening apparatus and is arranged above the leavening chamber.

20. The leavening apparatus of claim 17, wherein the climate control module is a module that is separate from the leavening chamber and to which the leavening chamber can be connected at least with its inlet.

21. The leavening apparatus of claim 17, wherein the climate control module comprises a temperature control device for controlling the temperature of the air stream generated during operation of the leavening apparatus and introduced into the leavening chamber.

22. The leavening apparatus of claim 17, wherein the device for generating water aerosol comprises means for generating aerosol having at least one additive.

23. The leavening apparatus of claim 17, further comprising two fans, with one fan being attached to the climate control module and another fan being attached to the outlet.

24. The leavening apparatus of claim 17, wherein an O₂ sensor adapted to transmit data to the control device is arranged in the leavening chamber.

25. A method for controlling the climate in a leavening chamber of a leavening apparatus for leavening dough pieces, in particular for operating a leavening apparatus according to claim 17, characterized in that:
a) climatic data influencing the leavening process are detected in the leavening chamber during the leavening process, wherein the variables temperature, absolute water content and the CO₂ content are detected as climatic ACTUAL values and are compared with the TARGET values for the leavening dough pieces, and
b) when a deviation between an ACTUAL value and the associated TARGET value is found, the climate in the leavening chamber is influenced to adjust the ACTUAL value to the TARGET value and, to influence the climate, an air stream is introduced into the leavening chamber via an upper inlet and passed through the leavening chamber whereby
(i) an influence is exerted with respect to an adjustment of the ACTUAL temperature to the TARGET temperature by the introduced air volume and/or the temperature of the introduced air volume,
(ii) an influence is exerted with respect to an adjustment of the ACTUAL absolute water content to the TARGET absolute water content by a corresponding water aerosol concentration of the air stream, and
(iii) an influence is exerted on the adjustment of the ACTUAL CO₂ value to the TARGET CO₂ value by a change to the volume flow of the air stream flowing through the leavening chamber.

26. The method of claim 25, wherein the volume flow is adjusted by changing the opening width of the outlet of the leavening chamber.

27. The method of claim 25, wherein the water aerosol to be entrained into the leavening chamber by the air stream comprises at least one additive.

28. The method of claim 27, wherein the additive is O₂ and/or ascorbic acid.

29. The method of claim 25, wherein the air pressure in the leavening chamber is additionally detected as an ACTUAL value and influence is exercised by the air volume introduced into the leavening chamber to adjust the ACTUAL pressure value to a TARGET pressure value.

30. The method of claim 25, wherein climatic data outside the leavening chamber that influence the dough pieces in the leavening chamber are detected, wherein at least one of the climatic variables temperature, absolute water content and air pressure is detected as ACTUAL external values and compared with the respective TARGET value as well as the difference between the TARGET value and the ACTUAL value detected in the leavening chamber, and when a deviation is found between an ACTUAL value detected outside the leavening chamber and the TARGET value, the climate in the leavening chamber is adjusted to the changing setpoint depending on the reaction inertness, whether and to what extent a change of the ACTUAL external value leads to a change of the ACTUAL value inside the leavening chamber.

31. The method of claim 30, wherein the climatic data detected outside the leavening chamber is data from the external environment of a building in which the leavening chamber is located.

32. The method of claim 30, wherein climatic forecasts which are included in the adjustment of the conditioning in addition to the value(s) detected outside the leavening chamber are included in the adjustment of the conditioning process.

33. The method of claim 25, wherein the air stream flows through the leavening chamber in a vertical direction.
